(19) United States
(12) Patent Application Publication
(10) Pub. No.: US 2024/0114910 A1
(43) Pub. Date: Apr. 11, 2024

(54) ENVIRONMENTALLY FRIENDLY LIQUID AND USES THEREOF

(71) Applicant: WEN-BIN HUANG, New Taipei (TW)

(72) Inventor: WEN-BIN HUANG, New Taipei (TW)

(21) Appl. No.: 18/045,818

(22) Filed: Oct. 11, 2022

(51) Int. Cl. A01N 59/06; A01N 25/30; A01N 31/04

(52) U.S. Cl. CPC A01N 59/06; A01N 25/30; A01N 31/04; A01N 25/002

(57) ABSTRACT

The present invention provides an environmentally friendly liquid which is applied to a surface of an object to form a cleaning effect. The environmentally friendly liquid is made by mixing multiple components, wherein the multiple components include: oil, occupying 73-83% by weight; sodium benzoate, occupies 0.1˜2.5% by weight; interface active agent, occupies 10˜20% by weight; silicon dioxide, occupies 0.4˜10% by weight; and aluminum oxide, occupies 0.1˜3% by weight.

### FIELD OF THE INVENTION

The present invention relates to an environmentally friendly liquid, specifically to one that achieves a cleaning effect and can be used as a biocide.

### BACKGROUND OF THE INVENTION

For food crops, the damages that needs prevention the most are from natural disasters and insects. For insect control, pesticides are conventionally applied to the crops to eliminate the potentially harmful insects. With those applications to the crops, the chemicals may stay on the surface of the crops applied or even in the soil where was applied; and if those crops harvested were not cleansed properly, it is possible that the chemicals would enter human body or exist in the environment through the food chain circle. Additionally, most pesticides are conventionally made of chemicals which may contain harmful substances or components to human body or the environment. With such accumulation of chemicals in the human body, it would certainly lead to harmful effects overtime; or, if accumulated in the environment, contamination from the pesticides residue would be the result.

In recent years, the government is actively promoting organic pesticides for use. Take the sunflower oil for example. A liquid mixture product named ‘Kuei Wu Lu’ in Taiwan has been used as a pesticide. It is mainly made from the sunflower oil and a dish washing liquid in which the main component is degradable and less harmful to human body or the environment. However, the effectiveness of this product only occurs on the insects and, with its formulation being a liquid mixture, separation among the mixture occurs in a short period of time, ranging from one day to several days. And this is apparently troublesome for the operators.

Therefore, it is an issue to be resolved in developing an eco-friendly liquid that eliminates living organism like the pests as well as provides a cleaning effect.

### SUMMARY OF THE INVENTION

An objective of the present invention is to provide an environmentally friendly liquid that achieves a cleaning effect.

To achieve the objective mentioned above, the present invention provides an environmentally friendly liquid applied to surfaces of objects for cleaning. The liquid is formed by mixing a plurality of components, including: oil 73˜83% by weight, Sodium benzoate 0.1˜2.5% by weight, surfactant 10˜20% by weight, Silicon dioxide 0.4˜10% by weight, and Aluminum oxide 0.1˜3% by weight.

In an embodiment, the surfactant contains hydroxide compounds 7˜20% by weight.

In an embodiment, the plurality of components further includes at least flour, sugar or eggs.

In an embodiment, the oil is vegetable oil.

The present invention also provides an environmentally friendly liquid applied to surfaces of objects for cleaning that contains a plurality of components and water. The plurality of components includes: oil 73˜83% by weight, Sodium benzoate 0.1˜2.5% by weight, surfactant 10˜20% by weight, Silicon dioxide 0.4˜10% by weight, and Aluminum oxide 0.1˜3% by weight; the water is mixed with the plurality of components at a ratio X:1, where X ranges from 200 to 800.

Additionally, the present invention also provides the environmentally friendly liquids described as above for biocides or for removing plants attached on objects.

Comparing to the conventional formulations, the environmentally friendly liquids of the present invention are formulated by mostly nontoxic and degradable components, significantly reducing the contaminations of negative effects on the environment. Also, the environmentally friendly liquids of the present invention can remain in a mixed liquid form in the long term and achieve an effective cleaning effect after mixed and diluted by water; they can also be used as biocides with more convenience, safety and costs for use.

### DETAILED DESCRIPTION OF THE PREFERRED EMBODIMENTS

In order to fully comprehend the objectives, features and efficacy of the present invention, a detailed description is described by the following substantial embodiments in conjunction with the accompanying drawings. The description is as below.

The description of unit, element and component in the present invention uses “one”, “a”, or “an”. The way mentioned above is for convenience, and for general meaning of the category of the present invention. Therefore, the description should be understood as “include one”, “at least one”, and include the singular and plural forms at the same time unless obvious meaning.

The description of comprise, have, include, contain, or another similar semantics has the non-exclusive meaning. For example, an element, structure, product, or device contain multi requirements are not limited in the list of the content, but include another inherent requirement of element, structure, product or device not explicitly listed in the content. In addition, the term “or” has an inclusive meaning instead of an exclusive one.

The objects herein include both physical substances and living organisms. The physical substances may be stones, metals, plastics or objects made by materials of the sorts; the living organisms may be plants, animals (such as insects), bacteria, and so on.

The environmentally friendly liquid, according to the present invention, is applied to surfaces of objects for cleaning; the liquid is formed by mixing a plurality of components that includes: oil, Sodium benzoate, surfactant, Silicon dioxide (SiO₂) and Aluminum oxide (Al₂O₃). Among the components, oil is the major one that takes 73˜83% by weight. Oils have a feature of stickiness, hence easier to attach and be retained on the surface of objects. In an embodiment, the oil is vegetable oil that contains more natural ingredients and is less possible to contain the environment, such as soybean oil, olive oil, sunflower oil, etc.

The Sodium benzoate takes 0.1˜2.5% by weight of the liquid and functions mainly as a preservative, preventing the oil described above to go bad or spoiled. Also, Sodium benzoate can kill the bacteria or is anti-bacteria. Although it is mostly synthetically formed, Sodium benzoate can be produced naturally by some plants (like berries); and a small amount of it is harmless to human bodies.

The surfactant takes 10˜20% by weight of the liquid and encourages the reaction and mixing between the Sodium benzoate and natural minerals (as described later). In an embodiment, the surfactant may include SALATT, the dish washing liquid, palm oil, soapberry oil or other natural ingredients; but the present invention is not limited to such application. In another embodiment, the surfactant contains hydroxide compounds, like water, 7˜20% by weight. That is, the surfactant contains completely hydroxide compounds or partial hydroxide compounds mixed with other ingredients.

The SiO₂ takes 0.4˜10% by weight of the liquid. It is composed by natural mineral powders and mainly encourages the oils to dissolve, increasing the adsorption area of the minor particles.

The Al₂O₃ takes 0.1˜3% by weight of the liquid. It is composed by natural mineral powders and mainly encourages the oils to dissolve, increasing the adsorption area of the minor particles, too.

In addition, in an embodiment, the plurality of components further includes at least flour, sugar or eggs. These are all edible ingredients that has fragrance. When at least one of the ingredients is added into the liquid, it can be an attraction for luring living organisms.

When preparing the liquid, simply mix the components stated above; as emulsification occurs, the sticky liquid is formed. The liquid can be formed instantly after mixing and then can be put to use right away. Moreover, even after being stored for a long time, it remains in the mixed liquid form without any separation occurred. Comparing to the conventional organic pesticides, it is more convenient for preparing and using. When the liquid is applied to surfaces of objects, it can be applied via spraying, spreading, soaking, and so on.

In an embodiment, the environmentally friendly liquid further includes water. Since the multiple components mentioned above would be sticky and more concentrated after the mixing and emulsification reaction, water can be added for dilution and a large amount of the liquid is produced while it is still efficient for the cleaning effect. In this embodiment, the ratio of water and the multiple components is X:1, where X ranges from 200 to 800.

The following is the functioning principle of the liquid. The liquid can be applied to the surface of objects either before or after being diluted by water. With the feature of stickiness, it can attach to the surfaces and form an isolating coating. The coating contains a great amount of oil that isolates the objects from the surrounding air, forming an air-tight space between the objects and the surrounding air. Therefore, when there are living organisms such as insects or moss, the coating formed thereon would cut off the oxygen source effectively; after letting sit for a while, a cleaning effect on the surface of the objects can be achieved.

The present invention further has the liquid used as a biocide. As stated, the liquid has a coating formed after being applied on the surface of the objects. When the object is pests or undesirable living organisms, the coating could interrupt their breathing mechanism and thereby eliminate them. For instance, normally the respiratory channel of insects is at their abdomen or legs and since the liquid contains edible ingredients, the insects would be lured to make contact. When their abdomen or legs contacts the liquid with a large contact area, the coating would be formed at where they made contact and further cut off their respiratory channel, thus eliminating them. On the other hand, the SiO₂ and Al₂O₃ in the liquid can cause damage to the soft tissues on insects' bodies. Therefore, the liquid of the present invention can be utilized in the agricultural pests control effectively, especially to small insects or pests such as the Genus Forcipomyia (Forcipomyia Taiwan), aphis, whiteflies, red mites, thrips, pieris larvae, etc. However, when the liquid is utilized as a biocide, the target is not limited to insects; other living organisms like the molds, bryophytes, snails and conches can be the target as well.

The present invention further includes providing the liquid for removing plants attached on objects. As stated above, when there is bryophytes or other similar plants existing on the surface of objects (like the wall or the ground), the coating formed by the liquid could isolate the plants from the surrounding environments, cutting off the oxygen source and causing them dead eventually. Thereby, the liquid achieves the efficacy of removing the plants attached on the surface of objects.

The present invention is disclosed by the preferred embodiments in the aforementioned description; however, it is contemplated for one skilled at the art that the embodiments are applied only for an illustration of the present invention rather than are interpreted as a limitation for the scope of the present invention. It should be noted that the various substantial alternation or replacement equivalent to these embodiments shall be considered as being covered within the scope of the present invention. Therefore, the protection scope of the present invention shall be defined by the claims.

What is claimed is:

1. An environmentally friendly liquid applied to surfaces of objects for cleaning, said liquid being formed by mixing a plurality of components, including:
oil, 73˜83% by weight,
sodium benzoate, 0.1˜2.5% by weight,
surfactant, 10˜18% by weight,
silicon dioxide, 0.4˜10% by weight, and
aluminum oxide, 0.1˜3% by weight.

2. The environmentally friendly liquid defined in claim 1, wherein the surfactant contains hydroxide compounds 7˜20% by weight.

3. The environmentally friendly liquid defined in claim 1, wherein the plurality of components further includes at least flour, sugar or eggs.

4. The environmentally friendly liquid defined in claim 1, wherein the oil is vegetable oil.

5. An environmentally friendly liquid applied to surfaces of objects for cleaning, said liquid comprising:
a plurality of components, including:
oil, 73˜83% by weight,
sodium benzoate, 0.1˜2.5% by weight,
surfactant, 10˜20% by weight,
silicon dioxide, 0.4˜10% by weight, and
aluminum oxide, 0.1˜3% by weight; and
water mixed with said plurality of components at a ratio X:1, where X ranges from 200 to 800.

6. The environmentally friendly liquid defined in claim 5, wherein the surfactant contains hydroxide compounds 7˜20% by weight.

7. The environmentally friendly liquid defined in claim 5, wherein the plurality of components further includes at least flour, sugar or eggs.

8. The environmentally friendly liquid defined in claim 5, wherein the oil is vegetable oil.

9. An environmentally friendly liquid defined in claim 1 put to use as a biocide.

10. An environmentally friendly liquid defined in claim 1 for removing plants attached on objects.
